(19) United States
(12) Patent Application Publication
(10) Pub. No.: US 2016/0102504 A1
(43) Pub. Date: Apr. 14, 2016

(54) END FITTING FOR SUCKER RODS

(71) Applicant: John Crane Production Solutions Inc., Sugar Land, TX (US)

(72) Inventors: Ryan Scott Gernentz, Midland, TX (US); Dustin Wayne Martin, Cypress, TX (US); Karol Hricisak, Sugar Land, TX (US)

(21) Appl. No.: 14/880,139

(22) Filed: Oct. 9, 2015

Related U.S. Application Data
(60) Provisional application No. 62/062,541, filed on Oct. 10, 2014.
(60) Provisional application No. 62/062,561, filed on Oct. 10, 2014.

(51) Int. Cl. E21B 17/04; F16B 7/00

(52) U.S. Cl. CPC E21B 17/04; F16B 7/00

(57) ABSTRACT

An end fitting attachable to an end of a sucker rod includes a generally cylindrical body having a receptacle portion, a coupling portion, and a longitudinal axis. The receptacle portion has a receptacle extending inwardly from an open end surface of the body along the longitudinal axis for receiving the end of the sucker rod therein, with the receptacle having at least one annular cavity. The coupling portion extends from a coupling end surface of the body opposite the open end surface and is configured to connect the end fitting to another component. The coupling portion may further include an area of predictive failure. A diagnostic sensor may be included in a cavity of the end fitting.

### CROSS-REFERENCE TO RELATED APPLICATION

This application claims priority pursuant to Title 35 U.S.C. §120 to U.S. Provisional Application No. 62/062,541, filed Oct. 10, 2014, entitled “Integrated Temperature Tool End Fitting” and U.S. Provisional Application No. 62/062,561, filed Oct. 10, 2014, entitled “Reduced Area End Fitting” the contents of both applications are hereby incorporated by reference as if fully set forth herein.

### FIELD

The disclosure relates generally to continuous composite or fiberglass rod assemblies for well pump drives and, in particular, to end fittings attachable to such rods.

### BACKGROUND

During production of a well, for example an oil well, the pressure from the well reservoir often becomes insufficient to transport hydrocarbons to the surface without the assistance of a pump. In such cases, a down-hole pump is typically lowered into the well, and attached to the lower end of a sucker rod string. The upper end of the rod string is then attached to a pump jack or similar reciprocating surface apparatus. Through reciprocation of the pump jack, the rod string is used to drive the down-hole pump, enabling continued production of the well.

For many years, sucker rods were generally made of steel. Due to the heavy weight of the steel rods, large pumping units were required and pumping depths were limited. It is now preferable to use sucker rods made of fiberglass, composite materials, and/or other similar materials (collectively referred to herein as “fiberglass”) with steel connectors joining the rods together to make a string of the required length.

Sucker rods are connected together in a string by steel connectors or end fittings attached to the ends of each rod. The end fittings comprise a rod receptacle at one end to receive the rod end, and a threaded coupling at the other end to threadingly connect to the end fitting of the next successive rod. The space between the interior wall of the rod receptacle and the external surface of the rod defines a space or annulus which is filled with epoxy or some other initially flowable adhesive similar to epoxy. The epoxy cures into a solid which bonds to the rod and takes the form of a series of wedges that cooperatively engage complementary surfaces in the rod receptacle to prevent rod pullouts (wherein the rod is pulled out of the connector rod receptacle) that would otherwise result in failure of the string.

The adhesive wedges transmit the axial forces of pumping from the steel connector to the fiberglass rod and vice-versa. Axial tension forces applied to a rod causes the wedges to impart compressive (i.e., lateral) loads to the end of the rod within the rod receptacle. The resultant deformations are transmitted throughout the rod body and vary depending on the magnitude of the force and the cross-sectional area of the rod. Abrupt changes in the cross-sectional area of the rod concentrate stress in certain areas of the rod. The adhesive wedges of sucker rod end fittings may change the cross-sectional area of the rod in comparison to the uncompressed rod body in such a way so as to concentrate stress forces on the rod end. The concentrated forces may exceed the structural strength of the composite material of the rod, resulting in rod failure from shearing, cracking or splintering, i.e., a catastrophic failure. In addition to potential contamination of a well bore, such catastrophic failure often makes recovery of the failed rod string difficult and time consuming. Thus, techniques that avoid the catastrophic failure of fiberglass sucker rods as disclosed herein, represent a welcome advancement in the art.

In addition, performance of a rod string, and the fiberglass rods in particular, can be greatly affected by the temperature of the well. For example, a standard fiberglass rod may be rated to a specific maximum temperature, such as 185° F., whereas a high temperature rod may be rated to a higher maximum temperature, such as 285° F. However, knowledge of temperature conditions of well bores may not typically be well known, leading to uncertainty as to whether the proper equipment is being used and the corresponding probability of a rod failure. Thus, techniques that provide additional insight to the temperature and other operating conditions to which a sucker rod string is exposed to assist in reducing the likelihood of a catastrophic failure of fiberglass sucker rods represent a welcome advancement in the art.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In a first aspect, a sucker rod and end fitting assembly includes a sucker rod with a sucker rod end and an end fitting secured to the sucker rod end. The end fitting includes a generally cylindrical body including a receptacle portion and a coupling portion along a longitudinal axis, with the receptacle portion having a receptacle extending inwardly from an open end surface of the body along the longitudinal axis for receiving the end of the sucker rod therein and the receptacle having at least one annular wedge-shaped cavity. The coupling portion extends from a coupling end surface of the body opposite the open end surface and is configured to connect the end fitting to another component and further includes an area of predictive failure.

In another aspect, an end fitting attachable to an end of a sucker rod includes a generally cylindrical body having a receptacle portion and a coupling portion along a longitudinal axis. The receptacle portion has a receptacle extending inwardly from an open end surface of the body along the longitudinal axis for receiving the sucker rod end therein, with the receptacle having at least one annular wedge-shaped cavity. The coupling portion extends from a coupling end surface of the body opposite the open end surface and is configured to connect the end fitting to another component, and further includes an area of predictive failure.

In still another aspect, an end fitting attachable to an end of a sucker rod includes a generally cylindrical body having a receptacle portion and a coupling portion along a longitudinal axis. The receptacle portion has a receptacle extending inwardly from an open end surface of the body along the longitudinal axis for receiving the sucker rod end therein, with the receptacle having at least one wedge-shaped annular cavity. The coupling portion extends from a coupling end surface of the body opposite the open end surface with the coupling portion being configured to connect the body to another component and including a cavity. A diagnostic sensor is removably sealed within the cavity.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a revolved cross-sectional view of a typical sucker rod end fitting;

FIG. 2 is a fragmentary sectional view of an end fitting in accordance with a first embodiment of the disclosure;

FIG. 3 is a revolved cross-sectional view of an end fitting in accordance with a second embodiment of the disclosure;

FIG. 4 is a revolved cross-sectional view of an end fitting in accordance with a third embodiment of the disclosure;

FIG. 5 is a schematic view of a portion of a rod string in accordance with the disclosure;

FIG. 6 is a revolved sectional view of an end fitting with a diagnostic sensor within a cavity of the end fitting; and

FIG. 7 is a fragmentary view of a portion of a pair of end fittings secured to a coupling with a diagnostic sensor located between the end fittings.

### DETAILED DESCRIPTION OF THE PRESENT EMBODIMENTS

In one aspect, the disclosure describes various techniques that provide for the controlled failure of fiberglass rod strings. Such controlled failure permits for cleaner recovery of, and minimized downtime to reinstate production of, a given well.

As described herein, controlled failure is provided through the introduction of an area of predictive failure to an end fitting for a fiberglass rod. This may be accomplished by providing a reduced cross-section area to a part of a coupling portion of the end fitting such that a predetermined level of tensile load on the end fitting will result in failure of the end fitting at that location. The area of predictive failure is configured to have a tinsel strength limit lower than tensile loading expected to cause catastrophic failure in other components used in a rod strings, in particular, the fiberglass composite rod and its connection to associated end fittings.

The area of predictive failure is configured by providing a cross-sectional area in the end fitting body having a maximum tensile strength that is exceeded prior to exposure of the end of the rod within the rod receptacle to catastrophic compressive loads and other destructive forces due to tensile loading of the rod string. The determination of the maximum tensile strength value for the area of predictive failure may be determined empirically or through mathematical calculation, such as by finite element analysis. By introducing into the end fitting body the area of predictive failure, tensile loads placed on the rod string that might otherwise induce failures in the body of a fiberglass rod, particularly at the connection between the fiberglass rod and the adhesive wedges within the rod receptacle, instead cause a failure of the end fitting at or in proximity to the area of predictive failure.

By thus avoiding a catastrophic failure of a fiberglass rod body, recovery and repair of the rod string is greatly facilitated and, in turn, production downtime of the well is minimized. Various embodiments of an end fitting in accordance with the disclosure are described in further detail below.

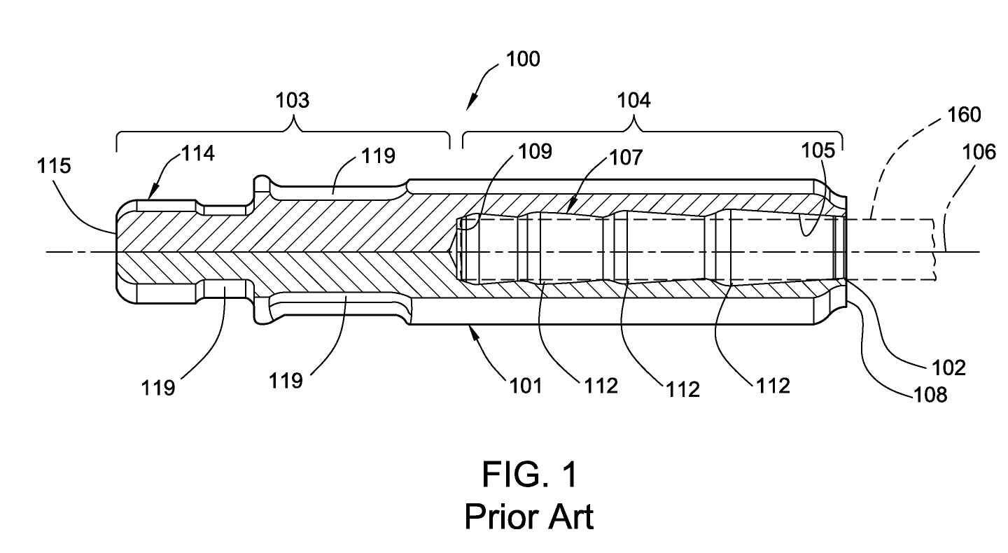

FIG. 1 generally illustrates a typical end fitting 100 in association with a fiberglass rod 160. In particular, the end fitting 100, which is typically fabricated from a suitable material such as steel, comprises a substantially cylindrical body 101 extending along a longitudinal axis 106.

Body 101 defines a generally solid coupling portion 103 and a generally annular receptacle portion 104. The receptacle portion 104 includes a rod receptacle or cavity 107 with an end opening 102 commencing at open end surface 108. Cavity 107 terminates at pilot bore surface 109. Connective interior surface 105 is a surface of revolution that defines a plurality of spaced conical shapes.

As is known in the art, when an end of a fiberglass rod 160 is inserted into the rod receptacle 107, an exterior surface of the fiberglass rod and the interior surface 105 of receptacle 107 form annular, wedge-shaped voids 112 around the fiberglass rod sometime referred to as annulii. When a suitable adhesive, such as heat-cured epoxy or other adhesive known in the art, is introduced into the receptacle 107 along with the end of the fiberglass rod, the adhesive fills the annular wedged-shaped voids 112 such that, the adhesive is cured and bonded to the fiberglass rod 160. The resulting solid portions of wedge-shaped adhesive cooperate with the complementary surfaces of the voids 112 to secure the end fitting 100 to the fiberglass rod.

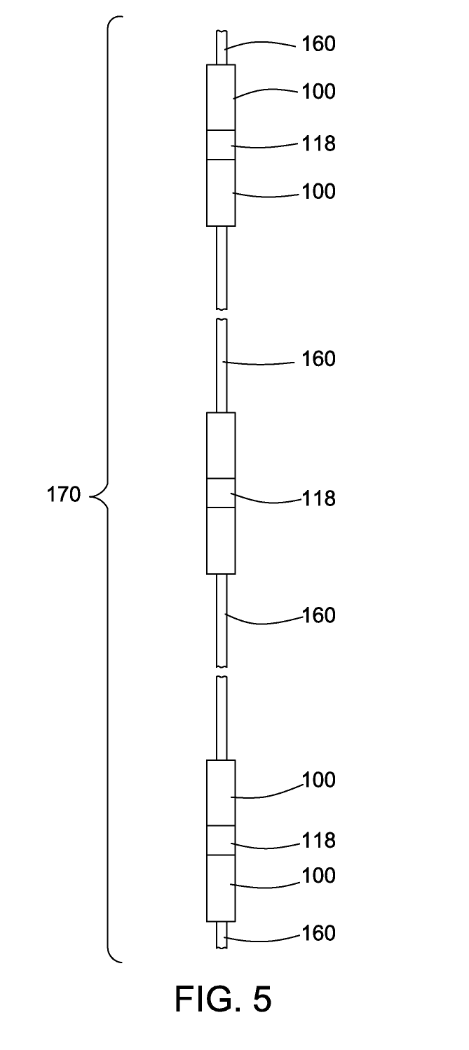

The coupling portion 103 of end fitting 100 includes a pin portion 114 commencing at a coupling or solid end surface 115 that that permits connection of the end fitting 100 to other end fittings. For example, the pin end portion 114 may include external threads (not shown) along its exterior surface configured to mate with complementary threads (not shown) of a coupling 118 seen in FIG. 5. As further shown, the coupling portion 103 of end fitting 100 may comprise additional structures such as wrench flats 119 located adjacent the pin portion 114.

As depicted in FIG. 5, a plurality of fiberglass rods 160 may be interconnected to form a rod string 170. An end fitting 100 may be secured to each end of a fiberglass rod 160. To form a rod string 170, adjacent end fittings 100 of adjacent fiberglass rods 160 are secured to a coupling 118. The coupling 118 may be formed as an annular tube with threads along an interior surface of the tube.

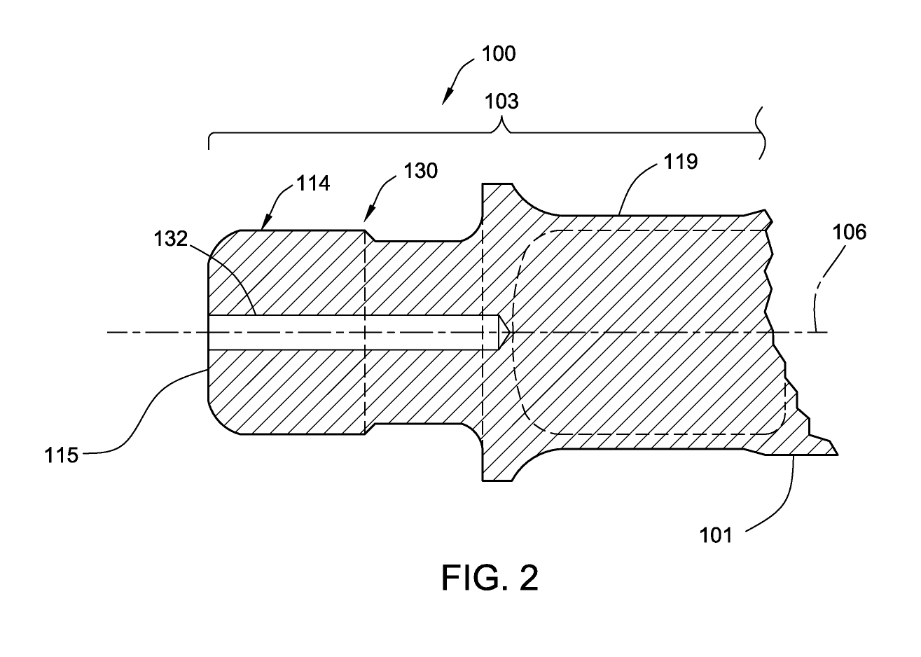

An embodiment of an end fitting 100 illustrative of the principles of the present disclosure is illustrated in FIG. 2. The end fitting 100 includes an area of predictive failure, generally designated 130, incorporated into the coupling portion 103 of sucker rod end fitting 100. As illustrated, the area of predictive failure 130 of this embodiment includes a blind bore or hole 132 aligned with a longitudinal axis 106 of the end fitting 100 extending through the body of the of the coupling portion 103 from solid end surface 115. In this embodiment, the bore 132 terminates within the body of the pin portion 114 generally near the beginning of the wrench flats 119 does not extend through the entire length of the coupling portion 103. Rather it terminates prior to reaching the pilot bore surface 109 located in receptacle or cavity 107.

The cross-sectional area of the area of predictive failure 130 is configured such that the maximum tensile strength at that portion of end fitting 100 will be exceeded, with the consequences of fracture of the end fitting at that location, prior to any other loads exerted upon the rod 160 or other components causing a catastrophic failure elsewhere, such as the connection between rod 160 and end fitting 100 within receptacle 107.

This area of predictive failure 130 is established by the outer diameter of the end fitting cylindrical body 101 within the area of predictive failure, the diameter of the blind bore or hole 132, and the material characteristics or strength of the body. The remaining cross-sectional area of end fitting body 101 dictates the maximum achievable tensile load upon the rod and end fitting before fracture of the end fitting 100 at the area of predictive failure. That value is established such that it is below the tensile load upon the assembly that will cause catastrophic failure elsewhere, such as in the connection of the rod end within the end fitting cavity 107.

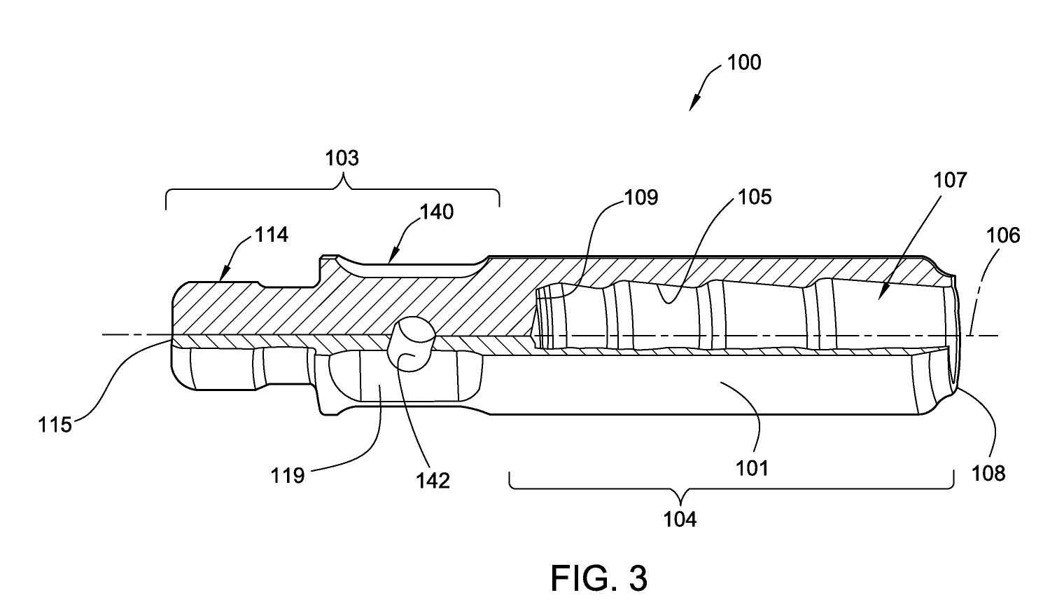

A second embodiment of an end fitting 100 is illustrated in FIG. 3. In this embodiment, an area of predictive failure 140 comprises a transverse bore 142 formed in the coupling portion 103 at a location along the longitudinal axis 106 of the end fitting 100 corresponding to the location of wrench flats 119. In this embodiment, the transverse bore passes through the body 101 of the end fitting 100 and is substantially centered on and intersects with the longitudinal axis 106 of the end fitting 100.

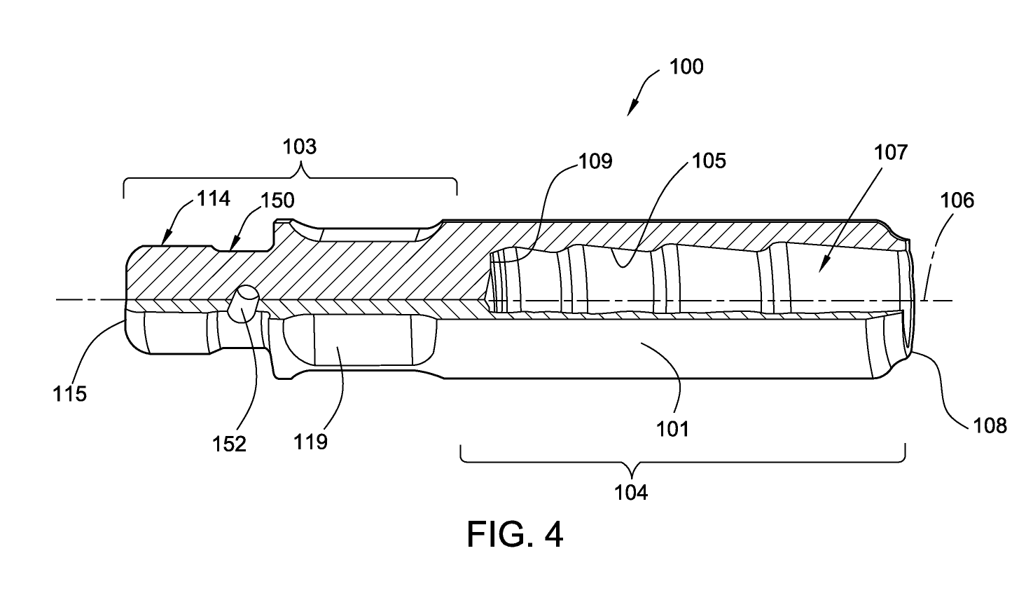

A third embodiment of the disclosure is further illustrated in FIG. 4 and is similar to the second embodiment in that an area of predictive failure 150, likewise comprises a transverse bore 152. However, in this embodiment, the transverse bore 152 in coupling portion 103 is formed at a location along the longitudinal axis 106 of the end fitting 100 intermediate pin portion 114 and the location of the wrench flats 119. In the embodiments of FIGS. 3-4, the transverse bore 152 is also longitudinally spaced from pilot bore surface 109.

In both embodiments illustrated in FIGS. 3-4, the transverse bore is depicted as being centered on and perpendicular to the longitudinal axis 106. However, this is not a requirement and such transverse bores may be off-center relative to the longitudinal axis 106 and/or could be formed at an angle other than 90° to the axis 106.

In each of the embodiments illustrated in FIGS. 2-4, the area of predictive failure is created by a bore formed within the coupling portion 103 of the end fitting 100. Such bores may be drilled at a predetermined diameter and depth as desired to create an area of predictive failure. In each of these embodiments, the particular failure threshold, i.e., the tensile axial load at or above which the coupling portion 103 will fail, can be specified by selecting dimensions of the bore according to the diameter of the end fitting body 101 and its material characteristics. For example, in the embodiments of FIGS. 2-4, increasing the diameter of the bore relative to a given diameter of end fitting body 101 will correspond to progressively lower failure thresholds for the end fitting 100.

Also, although the areas of predictive failure illustrated in FIGS. 2-4 are configured using bores in the body 101 of the end fitting 100, those having ordinary skill in the art will appreciate that other structural elements may be used to configure the area of predictive failure. For example, such features could be formed as a cavity or any type of recess in the exterior surface of the body 101. As one example, recesses within the external surface of cylindrical body 101 may be formed as annular notches or grooves of varying depths. More generally, using substantially any technique to reduce the load bearing capacity of an area of the coupling portion 103 (whether substantially within an interior region thereof or on an exterior surface thereof) will configure the desired area of predictive failure.

Further still, those of skill in the art will further appreciate that the specific dimensions of the area of predictive failure will be dictated in part by the materials used to form the end fitting 100. Consequently, the combined selection of specific materials used to fabricate the end fitting 100 and specific dimensions of the end fitting configuration permits even greater control of the desired failure threshold. Additionally, while the various embodiments illustrated in FIGS. 2-4 illustrate the area of predictive failure as established by a bore having at least one end open to the exterior of the end fitting 100, this is not a requirement and it is possible that each such bore could comprise a sealed bore. Sealing of such bores may be beneficial, for example, in those instances in which it is desirable to prevent corrosive materials from making contact with an interior surface of the end fitting.

By including an area of predictive failure in one or more end fittings 100, the likelihood of a catastrophic failure of one of the fiberglass rods 160 is reduced. In one embodiment, an area of predictive failure 130, 140, or 150 may be included in each end fitting 100 within a rod string 170. In another embodiment, the area of predictive failure, 130, 140, or 150 may be included in only some of the end fittings 100 within a rod string 170. For example, only end fittings 100 located at predetermined or random intervals along the rod string 170 may include an area of predictive failure.

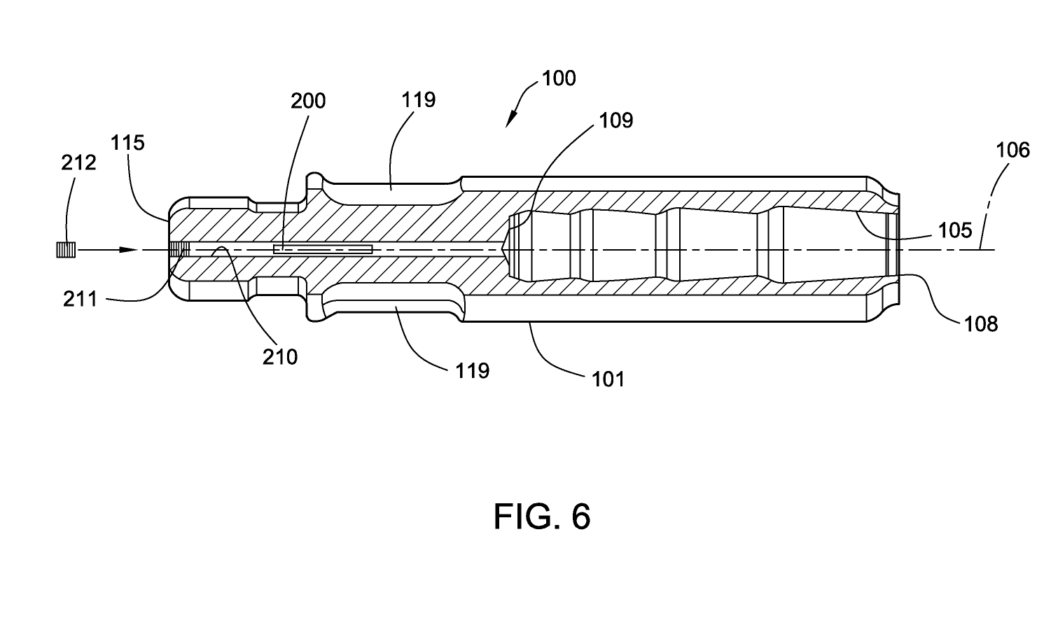

In a further aspect of the disclosure, a diagnostic sensor 200 (FIG. 6) may be removably positioned within the end fitting 100. While the end fitting 100 with the diagnostic sensor 200 sealed therein is positioned within the well bore, it is exposed to, and therefore able to determine and/or record, the operating conditions within the well bore as well as the operating characteristics experienced by the rod string 170 or to which the rod string is exposed. In one embodiment, after removing the rod string 170 from the well bore, the diagnostic sensor 200 may be removed from the end fitting 100 and the diagnostic sensor analyzed to determine the relevant data recorded by the sensor. The data may be used for any desired purpose such as by an operator of a well to better select the equipment used with the well. For example, the data may be used to select the material and/or strength of the components such as the end fitting 100, the adhesive, and the fiberglass rods 160.

The diagnostic sensor 200 may be removably positioned at any location within or at the end fitting 100. In one example depicted in FIG. 6, a sensor-receiving cavity 210 in which diagnostic sensor 200 may be positioned may be similar to blind bore 132 which forms the area of predictive failure 130 depicted in FIG. ?, but extend through the body 101 to the pilot bore surface 109. Sensor-receiving cavity 210 may take any form including those depicted as forming the area of predictive failure 130, 140, 150 in FIGS. 2-4 provided that the cavity is large enough for the diagnostic sensor 200 to be received therein.

In the embodiment depicted in FIG. 6, the introduction of a fiberglass rod 160 and adhesive into the receptacle 107 of the end fitting 100 may effectively seal a first end of the sensor-receiving cavity 210 at the pilot bore surface 109. Once the diagnostic sensor 200 has been placed in the sensor-receiving cavity 210, a second end of the sensor-receiving cavity adjacent solid end surface 115 of the pin portion 114 may also be sealed. For example, as depicted in FIG. 6, threads 211 may be provided on an interior surface of the sensor-receiving cavity 210. A suitable screw or similar component 212 having complementary threads may be secured to the threads 211 to seal the second end of the cavity 210. Those having ordinary skill in the art will appreciate that other reversible sealing techniques, such as plugs, adhesives, etc. may also be used to seal the second end of the sensor-receiving cavity 210.

The sensor-receiving cavity 210 may be sealed to the extent that, within manufacturing tolerances, the interior of the cavity 210 will be shielded from the environment of a well bore when the end fitting 100 is deployed therein, but nevertheless subject to the conditions to be measured within the well bore. For example, the thermal conductivity of the end fitting 100 will result in the diagnostic sensor 200 within sensor-receiving cavity 210 being subject to substantially the same temperature conditions as those within the well bore.

Although the sensor-receiving cavity 210 in which the diagnostic sensor 200 is located in FIG. 6 is depicted in the shape of a bore, in another example, the cavity may comprise a surface feature such as a notch, groove, hollow or the like formed on the external surface 102 of the end fitting 100. The diagnostic sensor 200 may be placed in the surface feature and then sealed using a removable element such as a cover configured to seal the surface feature with the diagnostic sensor inside. In one example, the removable element may be attached via suitable fastening mechanisms, such as bolts or screws. Alternatively, a suitable removable material such as an epoxy or adhesive may be used to fill in the surface feature, thereby encapsulating the diagnostic sensor 200.

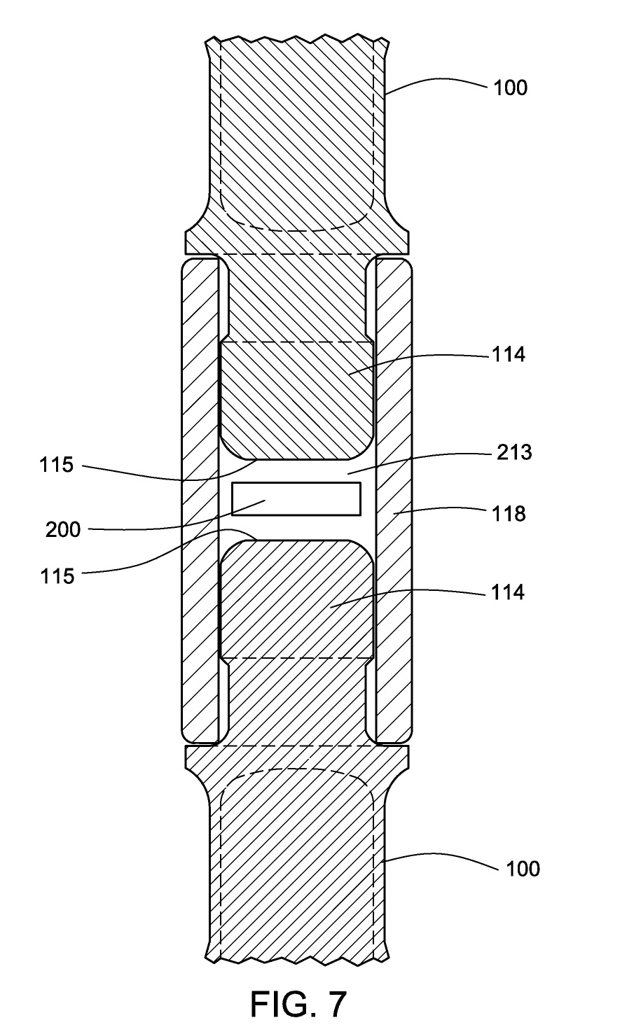

In another example depicted in FIG. 7, the sensor-receiving cavity may be located within the coupling 118 between the pin portions 114 of a pair of end fittings 100. In other words, upon securing the pin portion 114 of a pair of adjacent end fittings 100 to a coupling 118, a cavity or space 213 may be provided or defined between the solid end surfaces 115 of the end fittings 100 with a diagnostic sensor 200 positioned therein.

Diagnostic sensor 200 may be any desired type of device having dimensions permitting insertion thereof into the sensor-receiving cavity 210 of the end fitting 100 or cavity 213 of coupling 118. In one example, the diagnostic sensor 200 may be a temperature sensing device capable of recording temperature conditions at levels that may be reasonably expected within a well bore. By way of non-limiting example, in one embodiment, the temperature sensing device ay comprise a “PAPER THERMOMETER” device manufactured by the Paper Thermometer Company of Greenfield, New Hampshire, which are temperature sensitive labels that provide an irreversible indication that a given surface temperature of an object was reached. In another embodiment, the diagnostic sensor 200 may comprise a temperature sensing device capable of remotely communicating temperature readings while still deployed within a well bore.

In still another embodiment, the temperature sensing device may include a recording device capable of recording a plurality of temperatures to which the end fitting 100 was exposed over a period of time. In such case, the temperature sensing device (or just the recording device) may be removed as desired from end fitting 100 to access the temperature data.

In another example, the diagnostic sensor 200 may be a strain gauge sensor operative to analyze loads on the end fitting 100. As described above with respect to the temperature sensing device, data from the strain gauge sensor may be transmitted from the end fitting 100 or stored within the end fitting for subsequent access to the data. In still another example, the diagnostic sensor may be a pressure transducer for measuring pressure within the well bore. In such case, a port may be provided, for example, through a plug or seal member to allow atmospheric communication with the well bore to determine the pressure within the well bore. Pressure data may be transmitted from the pressure sensor within the end fitting 100 or stored within the end fitting for subsequent access to the data.

While particular preferred embodiments have been shown and described, those skilled in the art will appreciate that changes and modifications may be made without departing from the teachings disclosed herein. It is therefore contemplated that any and all modifications, variations or equivalents of the above-described teachings fall within the scope of the basic underlying principles disclosed above.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A sucker rod and end fitting assembly comprising:
a sucker rod including a sucker rod end; and
an end fitting secured to the sucker rod end, wherein the end fitting comprises:
a generally cylindrical body including a receptacle portion and a coupling portion along a longitudinal axis;
the receptacle portion having a receptacle extending inwardly from an open end surface of the body along the longitudinal axis for receiving the end of the sucker rod therein, the receptacle having at least one annular wedge-shaped cavity; and
the coupling portion extending from a coupling end surface of the body opposite the open end surface, and configured to connect the end fitting to another component,
the coupling portion including an area of predictive failure.

2. The assembly of claim 1, wherein the area of predictive failure comprises a cross-sectional area configured to have a maximum tensile strength such that upon a tensile load on the end fitting exceeding the maximum tensile strength, such tensile load creates forces causing catastrophic failure at the area of predictive failure prior to failure elsewhere in the sucker rod and end fitting assembly.

3. The assembly of claim 2, wherein the area of predictive failure includes a bore extending from the coupling end surface.

4. The assembly of claim 3, wherein the bore extends along the longitudinal axis.

5. The assembly of claim 2, wherein the cavity is a bore longitudinally spaced from the coupling end of the body and the receptacle.

6. The assembly of claim 2, wherein the bore intersects with the longitudinal axis.

7. The assembly of claim 2, wherein the bore is offset from the longitudinal axis.

8. The assembly of claim 2, further including an adhesive secured to the sucker rod within the receptacle to secure the sucker rod end within the receptacle.

9. An end fitting attachable to an end of a sucker rod, comprising:
a generally cylindrical body including a receptacle portion and a coupling portion along a longitudinal axis;
the receptacle portion having a receptacle extending inwardly from an open end surface of the body along the longitudinal axis for receiving the sucker rod end therein, the receptacle having at least one annular wedge-shaped cavity; and
the coupling portion extending from a coupling end surface of the body opposite the open end surface, and configured to connect the end fitting to another component,
the coupling portion including an area of predictive failure.

10. The end fitting of claim 9, wherein the area of predictive failure includes a bore into the body extending from the coupling end surface along the longitudinal axis.

11. The end fitting of claim 9, wherein the area of predictive failure is a bore in the body extending at an angle to the longitudinal axis between the coupling end surface and the receptacle.

12. The end fitting of claim 11 wherein the bore intersects with the longitudinal axis.

13. The end fitting of claim 11, wherein the bore is offset from the longitudinal axis.

14. The end fitting of claim 1, wherein the coupling portion includes a mating structure adjacent the coupling end and wrench flats longitudinally between the mating structure and the receptacle of the receptacle portion, and the area of predictive failure is longitudinally between the coupling end and the wrench flats.

15. The end fitting of claim 1, further including a diagnostic sensor removably disposed within a portion of the area of predictive failure.

16. An end fitting attachable to an end of a sucker rod, comprising:
a generally cylindrical body including a receptacle portion and a coupling portion along a longitudinal axis;
the receptacle portion having a receptacle extending inwardly from an open end surface of the body along the longitudinal axis for receiving the sucker rod end therein, the receptacle having at least one wedge-shaped annular cavity; and
the coupling portion extending from a coupling end surface of the body opposite the open end surface, the coupling portion being configured to connect the body to another component and including a cavity; and
a diagnostic sensor removably sealed within the cavity.

17. The end fitting of claim 16, wherein the diagnostic sensor is a temperature sensing device.

18. The end fitting of claim 16, wherein the cavity is a bore extending from the coupling end surface of the body towards the receptacle.

19. The end fitting of claim 16, wherein the cavity is a bore longitudinally spaced from the coupling end surface of the body and the receptacle.

20. The end fitting of claim 16, wherein the diagnostic sensor is a strain gauge sensor.
